(19) United States
(12) Patent Application Publication
(10) Pub. No.: US 2008/0124598 A1
(43) Pub. Date: May 29, 2008

(54) Activation of solid oxide fuel cell electrode surfaces

(76) Inventors: Monika Backhaus-Ricoult, Horseheads, NY (US); Kimberley Louise Work, Elmira, NY (US)

Correspondence Address: CORNING INCORPORATED, SP-TI-3-1, CORNING, NY, 14831, US

(21) Appl. No.: 11/605,882

(22) Filed: Nov. 29, 2006

(51) Int. Cl. H01M 4/02; H01M 8/10; B08B 3/00; B08B 3/08

(52) U.S. Cl. 429/27; 429/33; 134/42; 134/27

(57) ABSTRACT

A solid oxide fuel cell that is capable of increased power density is disclosed. A ceramic electrolyte comprising at least one surface, wherein at least a portion of at least one surface is substantially free of segregated impurities is also disclosed. A solid oxide fuel cell comprising an anode and a cathode, each comprising an active surface, and an electrolyte having a surface, wherein at least a portion of each of the cathode active surface, the anode active surface, and the electrolyte surface are substantially free of segregated impurities is also disclosed. Methods for removing at least a portion of a segregated impurity from a solid oxide fuel cell either prior to or during assembly, or after a period of fuel cell operation are also disclosed.

### BACKGROUND OF THE INVENTION

1. Field of the Invention

The present invention relates to ceramic surfaces, ceramic electrolytes, and solid oxide fuel cells having electrolyte and/or electrode surfaces substantially free of surface segregated impurities and passivating species.

2. Technical Background

Solid oxide fuel cells (SOFC) have been the subject of considerable research in recent years. Solid oxide fuel cells convert the chemical energy of a fuel, such as hydrogen and/or hydrocarbons, into electricity via electrochemical oxidation of the fuel at temperatures, for example, of about 700 to about 1000° C. A typical SOFC comprises an oxygen ion-conducting electrolyte layer sandwiched between a cathode layer and an anode layer. Molecular oxygen is reduced at the cathode and incorporated in the electrolyte, wherein oxygen ions are transported through the electrolyte to react with, for example, hydrogen at the anode to form water.

Fuel cells, such as solid oxide fuel cells, can theoretically provide greater energy conversion efficiency than conventional combustion engines; however, the power density of solid oxide fuel cells developed to date has not reached theoretical targets. One potential limitation on the power density of a solid oxide fuel cell is the resistance of the materials used in fabricating the fuel cell, such as the electrolyte and/or electrode materials. Another potential limitation on the power density of solid oxide fuel cells is the polarization resistance of the electrodes. The cathode, for example, of a solid oxide fuel cell can exhibit a high polarization resistance, due in part to the presence of surface segregated contaminants, impurities, and/or passivating species at the surface of the electrode where the oxygen reduction reaction occurs.

The high operating temperature of a solid oxide fuel cell can also lead to movement of contaminants, impurities, and/or passivating species contained with the materials from which the fuel cell is constructed. Over time, these contaminants, impurities, and/or passivating species can segregate at the surface of the electrodes and electrolyte, and further contribute to polarization resistance and reduce the power density of the solid oxide fuel cell.

Thus, there is a need to address the power density of a solid oxide fuel cell, the presence and surface segregation of contaminants, impurities, and passivating species in fuel cell materials, and other shortcomings associated with solid oxide fuel cells and methods for fabricating and operating solid oxide fuel cells. These needs and other needs are satisfied by the articles, devices and methods of the present invention.

### SUMMARY OF THE INVENTION

The present invention relates to ceramic surfaces, ceramic electrolytes, and solid oxide fuel cells having an electrolyte and/or electrodes that are substantially free of surface segregated impurities and/or passivating species. The present invention addresses at least a portion of the problems described above through the use of a novel cleaning method and electrode surface activation method.

In a first embodiment, the present invention provides a ceramic electrolyte comprising at least one surface, wherein at least a portion of at least one surface is substantially free of segregated impurities.

In a second embodiment, the present invention provides a solid oxide fuel cell electrode having at least one active surface, wherein at least a portion of the at least one active surface is substantially free of segregated impurities.

In a third embodiment, the present invention provides a solid oxide fuel cell comprising: an anode and a cathode, each comprising an active surface; and an electrolyte having a surface; wherein at least a portion of each of the cathode active surface, the anode active surface, and the electrolyte surface are substantially free of segregated impurities.

In a fourth embodiment, the present invention provides a ceramic article comprising at least one surface, wherein at least a portion of at least one surface is substantially free of segregated impurities.

In a fifth embodiment, the present invention provides a method for removing at least a portion of a segregated impurity from at least a portion of an active surface of a component of an assembled or unassembled solid oxide fuel cell comprising contacting at least a portion of the active surface with a cleaning agent, wherein the contacting is at a time and temperature sufficient to remove substantially all of the at least a portion of the segregated impurity.

Additional embodiments and advantages of the invention will be set forth, in part, in the detailed description, figures, and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the present invention and together with the description, serve to explain, without limitation, the principles of the invention. Like numbers represent the same elements throughout the figures.

FIG. 1 illustrates X-ray photoelectron spectroscopy data depicting Silicon 2p spectra of an as-prepared electrolyte fired at room temperature, and the same electrolyte after HF cleaning, in accordance with various embodiments of the present invention.

FIG. 2 illustrates the current density measured at 0.7 volts over a period of more than 100 hours for a device comprised of a 3YSZ electrolyte screen printed with a LSM/3YSZ cathode, a Ni/8YSZ anode, and Ag-based current collectors, operated in air and 30% hydrogen, in accordance with various embodiments of the present invention.

FIG. 3 illustrates X-ray photoelectron spectroscopy data depicting Silicon 2p spectra of an as-processed anode (1), the as-processed anode after cleaning with a dilute HF solution (2), a separate anode polluted by prolonged exposure to a silicate material (3), and the same polluted anode after cleaning with diluted HF solution (4), all in accordance with various embodiments of the present invention.

FIG. 4 illustrates the current density measured in single cells comprised of 3YSZ electrolytes, Ni/8YSZ anodes, and platinum-current collectors and counter electrodes, cleaned in accordance with various embodiments of the present invention.

FIG. 5 illustrates secondary ion mass spectrometry depth profiles of LSM/3YSZ cathodes prior to cleaning, after cleaning with a 3% HF solution, and after heating the HF cleaned electrode to 700° C. Depth profiles are illustrated for silicon and phosphorus. The signal intensities have been normalized to the zirconium intensity.

FIG. 6 illustrates the current density measured in cathode pump cells comprised of 3YSZ electrolyte, LSM/3YSZ electrodes, and Ag-based current collectors positioned on each side of the electrolyte. Current density measurements were obtained at 0.5 volts at 750° C. in air.

FIG. 7 illustrates electrochemical impedance spectroscopy data for cathode pump samples comprised of 3YSZ electrolyte sheet, an LSM/3YSZ cathode, and Ag-based current collectors positioned on each side of the electrolyte sheet.

### DETAILED DESCRIPTION OF THE INVENTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its currently known embodiments. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all embodiments of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes embodiments having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optional component” means that the component can or can not be present and that the description includes both embodiments of the invention including and excluding the component.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. Ranges can be described in varying units, such as for example, atomic percent and/or cation %. If multiple units are used to describe a range, it will be understood that each range, as well as various combinations of the ranges, represent various embodiments of the invention.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, an “atomic percent” or “atomic %” of an element, unless specifically stated to the contrary, refers to the ratio of the number of atoms of the element to the total number of atoms in the composition or analysis area in which the component is included, expressed as a percentage.

As used herein, a “cation percent”, “cation %”, or “cat %” of a species, unless specifically stated to the contrary, refers to the ratio of the atomic surface concentration of a cation to the total atomic surface concentration of all cations in the composition or analysis area in which the cation is included, expressed as a percentage.

As briefly introduced above, the present invention provides a method for cleaning at least some of the materials, such as the surfaces, and specifically the surfaces of the ceramic electrolyte and the inner surfaces of the electrodes. The cleaning and electrode activation method of the present invention and the resulting solid oxide fuel cell and materials can provide increased power density over conventional solid oxide fuel cells that have not undergone such a cleaning and activation procedure. The cleaning and activation method of the present invention can improve initial and/or long-term performance of a fuel cell. The cleaning and activation method can also be used as a periodic regeneration process to clean and/or improve the performance of a solid oxide fuel cell.

Although the electrolytes, electrodes, and methods of the present invention are described below with respect to a solid oxide fuel cell, it should be understood that the same or similar electrolytes, electrodes, and methods can be used in other applications where a need exists to remove surface segregated impurities and/or passivating species. Accordingly, the present invention should not be construed in a limited manner.

### Solid Oxide Fuel Cell

A conventional solid oxide fuel cell is comprised of a ceramic electrolyte that can comprise any ion-conducting material suitable for use in a solid oxide fuel cell. The electrolyte can be comprised of a polycrystalline ceramic such as zirconia, yttria, scandia, ceria, or a combination thereof, and can optionally be doped with at least one dopant selected from the group consisting of the oxides of Y, Hf, Ce, Ca, Mg, Sc, Nd, Sm, Eu, Gd, Tb, Dy, Ho, Er, Tm, Yb, Lu, In, Ti, Sn, Nb, Ta, Mo, W, or a mixture thereof. The electrolyte can also comprise other filler and/or processing materials. An exemplary electrolyte is comprised of zirconia doped with yttria, also referred to as yttria stabilized zirconia (YSZ).

The electrolyte can comprise any geometry suitable for the solid oxide fuel cell being fabricated such as, for example, tubular and/or planar. A typical design employs a planar electrolyte sheet comprised of zirconia doped with yttria. A solid oxide fuel cell can further comprise at least one anode and at least one cathode, positioned on opposing surfaces of an electrolyte. A solid oxide fuel cell can comprise a single chamber, wherein both the anode and the cathode are on the same side of the electrolyte. The electrodes can comprise any materials suitable for facilitating the reactions of a solid oxide fuel cell. The anode and cathode can comprise different or similar materials and no limitation to materials or design is intended. The anode and/or cathode can form any geometric pattern suitable for use in a solid oxide fuel cell. The electrodes can be a coating or planar material positioned parallel to and on the surface of the ceramic electrolyte. The electrodes can also be arranged in a pattern comprising multiple independent electrodes. For example, an anode can be a single, continuous coating on one side of an electrolyte or a plurality of individual elements, such as strips, positioned in a pattern or array.

An anode can comprise, for example, yttria, zirconia, nickel, or a combination thereof. An exemplary anode can comprise a cermet comprising nickel and the electrolyte material such as, for example, zirconia.

A cathode can comprise, for example, yttria, zirconia, manganate, ferrate, cobaltate, or a combination thereof. Exemplary cathode materials can include, yttria stabilized zirconia, lanthanum strontium manganate, lanthanum strontium ferrate, and combinations thereof.

The reactions occurring in a solid oxide fuel cell typically occur at an active surface of either an electrode and/or an electrolyte. The reduction of molecular oxygen can occur at the active surface of the cathode, and the oxidation of fuel, such as hydrogen, can occur at the active surface of the anode. The active surface of, for example, the anode and/or the cathode comprise a portion of the electrode surface in contact with the reactants, such as, for example, hydrogen and/or oxygen. The active surface can further comprise a portion of the electrode surface in contact with the electrolyte. The active surface can also comprise an external and/or an internal surface of the electrolyte. An external surface, as used herein, refers to the exterior portion of a surface that is visible and can be directly accessed without the aid of diffusion or permeation. An internal surface, as used herein, refers to that portion of a material that is accessible to a gas and/or a liquid, such as a fuel or reactant gas, of a solid oxide fuel cell, through a diffusion and/or permeation mechanism. For example, conventional solid oxide fuel cell electrolytes are comprised of porous materials. The internal surface of such an electrolyte is that portion of the surface comprised of pores and/or channels within the porous structure of the electrolyte and that is accessible to a gas or solution.

The power generated by a solid oxide fuel cell can increase in relation to active surface in the cell.

### Surface Segregation of Impurities and Passivating Species

The materials used to fabricate the components of a fuel cell can contain various impurities. The electrolyte and/or electrodes of a solid oxide fuel cell can comprise impurities. Other components, such as, for example, a seal, a frame, and/or other stack materials, can also comprise impurities that can migrate to an active surface of a solid oxide fuel cell during operation. Such migration can include diffusion, surface diffusion, vapor transport, as well as other known methods of migration and combinations thereof. Glass frits, used to seal a solid oxide fuel cell, can contribute significant amounts of glass forming impurities to an active surface during fuel cell operation. Additional sources of impurities can include processing additives used in fabrication of fuel cell components.

These impurities can comprise glass forming materials such as, for example, compounds comprising silicon, phosphorus, and/or boron. Other impurities such as, for example, compounds comprising aluminum, sodium, and/or potassium, can have deleterious effects if present together with a glass forming impurity or if present alone in sufficient quantity. These impurities are ideally absent or present only at low average overall concentration in a solid oxide fuel cell. The average overall concentration of these impurities can typically range from about 1 ppm to about 10,000 ppm, and can frequently range from about 10 ppm to about 100 ppm.

During fuel cell operation, the electrolyte and electrodes are subjected to operating temperatures of from about 600° C. to about 1,000° C. At temperatures of greater than about 800° C., impurities and passivating species having a high surface affinity can segregate as oxides at, for example, a portion of the active surface of an electrode. Such segregated impurities and/or passivating species can block at least a portion of the active surface of an electrode, thus limiting the reaction occurring at the electrode and the power generated by the fuel cell. A surface segregation of glass forming impurities and/or passivating species at the cathode can, for example, block at least a portion of the active surface and inhibit the exchange of oxygen between the electrolyte and the gas phase. Segregation of glass forming impurities and/or passivating species to a level of about a single monolayer can inhibit virtually all oxygen exchange at the cathode. Performance degradation due to surface segregated impurities can be a rapid process or can occur slowly over a period of time. The rate of degradation and resulting performance are dependent on the concentration and nature of the specific impurities.

Surface concentrations of segregated impurities and/or passivating species can be significantly higher than bulk concentrations and can range up to, for example, from about 1 wt. % to about 10 wt. %, for example 1, 2, 3, 5, 7, 9, or 10 wt. %, over a depth of about 2 nm, or from about 1 wt. % to about 100 wt. %, for example 1, 2, 4, 8, 10, 20, 30, 40, 60, 80, 90, or 100 wt. %, in an outermost surface layer. It should be noted that different experimental techniques can provide various analysis spot sizes and/or depth profiles. Surface measurements obtained by conventional X-ray photoelectron spectroscopy (XPS) can have penetration depths of up to, for example, 2 nm to 3 nm or more. Other techniques or variations of instrumental setup can provide chemical information from various penetration depths, such as for example, less than 0.5 nm to 2 nm, or greater than 2 nm to 10 nm. The measurement values obtained by such techniques can provide varying results (e.g., higher concentrations of segregating components when more surface sensitive techniques are employed). Techniques, such as secondary ion mass spectrometry (SIMS), can provide depth profiles for the concentration of segregated impurities. All of the surface concentrations described herein, unless stated to the contrary, refer to techniques having a penetration depth of from about 2 nm to about 3 nm. It is understood that other techniques can provide varying surface concentration levels and the present invention is intended to include such embodiments.

Removal of at least a portion of a surface segregated impurity from an electrolyte and/or electrode can increase the available active surface of the solid oxide fuel cell, decrease the charge transfer resistance associated with electrode reactions, and thus, improve the power density generated by the fuel cell during operation. The portion of a segregated impurity removed can be based on the specific species of impurity, the type of impurity (e.g., glass forming), the location of the impurity, the thickness of the segregated impurity, the attachment of the impurity to the surface, etc. In one embodiment, the removed portion of a segregated impurity is dependent upon the location of the impurity. In another aspect, the removed portion of a segregated impurity is dependent upon the type of impurity species present. To prevent a loss of power density, the surface concentration of segregated glass forming impurities and/or passivating species such as, for example, oxides of silicon, phosphorus, and/or boron, if present, are in one embodiment less than about 10% cation %, for example, less than about 10, 9, 7, 5, 3, 2, or 1 cation %, or preferably less than about 2 cation %, for example, less than about 2, 1.5, 1, 0.5, 0.3, 0.2, 0.1, or 0.05 cation %. Expressed in atomic %, species such as, for example, oxides of silicon, phosphorus, and/or boron, if present, are in one embodiment less than about 5 atomic %, for example less than about 5, 4, 3, 2, or 1 atomic %, or preferably less than about 1 atomic %, for example, less than about 1, 0.8, 0.4, 0.2, or 0.1 atomic %.

Other impurities and/or passivating species, such as oxides of aluminum, sodium, and/or potassium, and/or compounds comprising strontium, manganese, and/or iron do not typically form glasses in the absence of a glass forming impurity, but can interact with a glass forming impurity to further block a portion of an active surface. For example, oxides of aluminum can typically be tolerated at surface concentrations of up to, 2 cation % to 5 cation %, or 1 atomic % to 2 atomic %, for example 0.1, 0.3, 0.5, 0.7, 1.0, 1.3, 1.5, 1.8, or 2.0 atomic %, in the absence of a glass forming impurity, without adversely affecting power density. Similarly, oxides of sodium and/or potassium can be tolerated at levels of up to, 0.5 cation %, or 0.3 atomic %, for example 0.05, 0.1, 0.15, 0.2, or 0.3 atomic %, in the absence of a glass forming impurity, without adversely affecting power density. In the presence of a glass forming impurity, the surface concentration of these impurities (e.g. oxides of aluminum, sodium, and/or potassium) in one embodiment is less than about 10% cation %, for example, less than about 10, 9, 7, 5, 3, 2, or 1 cation %, or preferably less than about 2 cation %, for example, less than about 2, 1.5, 1, 0.5, 0.3, 0.2, 0.1, or 0.05 cation %. The term segregated impurity, as used herein, is intended to include the glass forming impurities, other impurities, passivating species, and compounds described above, and is not intended to be limited to a particular species or type of impurity. A segregated impurity can comprise a material intentionally added to a component and/or a fuel cell for a specific purpose. For example, silica can be added to an electrolyte composition as a sintering aid and can later segregate as an impurity during fuel cell operation. The term segregated impurity is intended to include such an intentionally added material.

### Cleaning and Activation Method

The electrolyte and/or electrodes, and specifically the active surfaces of the electrolyte and/or electrodes, of a solid oxide fuel cell can be cleaned with the methods of the present invention to remove at least a portion of a segregated impurity.

In one embodiment, the present invention provides a method for removing at least a portion of a surface segregated impurity from at least a portion of an active surface of a solid oxide fuel cell. The method comprises contacting at least a portion of the active surface with a cleaning agent comprising at least one of an acidic and/or basic solution capable of dissolving at least a portion of the surface segregated impurity, an organic solvent capable of dissolving at least a portion of the surface segregated impurity, a gas capable of removing at least a portion of the surface segregated impurity, or a combination thereof, wherein the contacting is at a time and temperature sufficient to remove substantially all of the at least a portion of the surface segregated impurity. In a specific embodiment, the present invention removes a portion of the surface segregated impurity from at least a portion of an active surface. It is not necessary that a surface segregated impurity be completely removed or that the entire active surface be cleaned. In a preferred embodiment, all or substantially all of a surface segregated impurity is removed.

The active surface of the present invention can comprise an external and/or internal surface of the electrolyte, an electrode surface in contact with the reactants, such as, for example, hydrogen and/or oxygen, and/or an electrode surface in contact with the electrolyte. In various embodiments, a segregated surface impurity is at least partially removed from an external surface of an electrolyte, an internal surface of the electrolyte, an electrode surface designed to contact reactants, an electrode surface in contact with the electrolyte, an electrode surface both in contact with the electrolyte and designed to contact reactants, or a combination thereof.

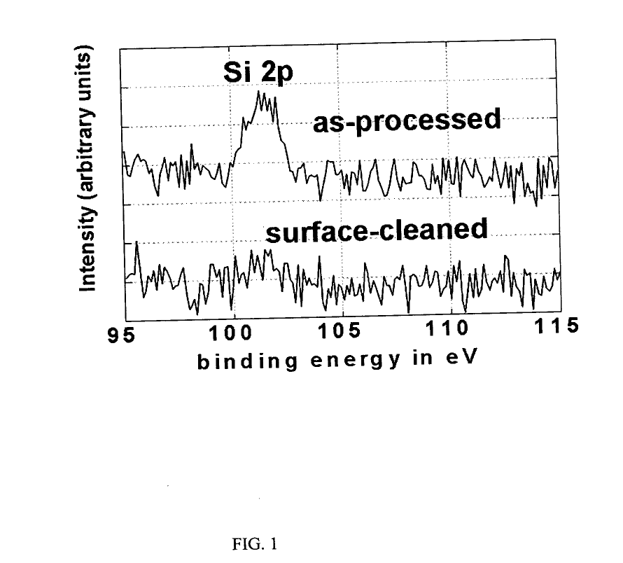

In one embodiment, the cleaning method of the present invention is performed on at least a portion of an electrolyte not comprising an electrode. In this embodiment, one or more electrodes can be attached to the electrolyte after the cleaning procedure is complete. X-ray photoelectron spectroscopy data of exemplary as-prepared (un-cleaned) and cleaned electrolytes are depicted in FIG. 1. The figure illustrates a significant reduction in the surface concentration of silicon in the analysis area of the cleaned electrolyte relative to the as-prepared electrolyte. In another embodiment, the cleaning procedure is performed on at least a portion of an electrolyte and at least a portion of one electrode. In yet another embodiment, the cleaning procedure is performed on at least a portion of an electrolyte and portions of both the anode and the cathode. It is preferred that the cleaning procedure be performed on at least a portion of an electrolyte and on portions of both the anode and the cathode. It is more preferred that the cleaning procedure be performed on an electrolyte and both the anode and the cathode. The term “fully cleaned”, as used herein, is intended to refer to a cleaning method or an article or device in which all active surfaces (i.e., electrolyte and electrodes) have been cleaned.

The segregated impurity removed by the present invention can be a glass forming material. In one embodiment, a segregated impurity can comprise at least one of an oxide of silicon, phosphorus, boron, or a combination thereof. The segregated impurity can further comprise other impurities such as an oxide of aluminum, sodium, potassium, or a combination thereof. The segregated impurity removed by the present invention can comprise materials used in the fabrication of an electrode and/or an electrolyte that can segregate and passivate at least a portion of a surface of an electrode and/or electrolyte. The specific segregated impurity will be dependent on the electrolyte and/or electrodes, together with the other components, such as a glass seal, used in fabricating a solid oxide fuel cell. The term segregated impurity can comprise any combination of individual segregated impurities, such as for example, glass forming impurities, and optionally, other impurities. In various embodiments, the segregated impurity of the present invention comprises an oxide of silicon, a combination of oxides of silicon and phosphorus, a combination of oxides of boron and silicon, and/or a combination of oxides of silicon, phosphorus, and boron. Additionally, oxides of aluminum, sodium, and/or potassium can be present.

The segregated impurity removed by the present invention can comprise a passivating species, such as for example, strontium, manganese, and/or iron, that can originate from, for example, an electrode of the solid oxide fuel cell.

The cleaning agent of the present invention can be any such agent suitable for removing at least a portion of a segregated impurity from at least a portion of an active surface of a solid oxide fuel cell. In one embodiment, the cleaning agent is an acidic solution. The acidic solution can be any solution capable of removing a segregated impurity, such as, for example, a hydrochloric acid solution, a hydrofluoric acid solution, or a combination thereof. In another embodiment, the cleaning agent is a basic solution, such as, for example, a sodium hydroxide solution. In another embodiment, the cleaning agent is an organic solvent capable of dissolving the segregated impurity. In yet another embodiment, the cleaning agent is a gas, such as, for example, hydrogen, fluorine, hydrogen chloride, hydrogen fluoride, nitrogen trifluoride, or a combination thereof. The gas can either directly remove the segregated impurity or can indirectly remove the segregated impurity by first modifying the oxidation state of the impurity, whereby the modified impurity can be removed by rinsing or by further contact with a cleaning agent described herein. In one embodiment, the gas comprises hydrogen chloride, hydrogen fluoride, nitrogen fluoride, or a combination thereof, and directly removes the segregated impurity. In another embodiment, the gas comprises hydrogen and indirectly removes the segregated impurity by first modifying the oxidation state (e.g. reducing silicon dioxide to a volatile silicon monoxide) of the segregated impurity. In this embodiment, the hydrogen cleaning agent is distinguished from the fuel and can be contacted with individual fuel cell components, an unassembled fuel cell, or an assembled fuel cell, during a period in which the fuel cell is not operating. In yet another embodiment, the cleaning agent can comprise a solid such as, for example, a powder that can decompose to produce a substance that can remove at least a portion of a surface segregated impurity. In a specific embodiment, the cleaning agent is a powder comprising a fluorine containing compound such as, for example, a fluoride that can decompose over a period of time to release a fluorine containing gas. Such a powdered cleaning agent can be introduced in the fuel cell at a single time and allowed to slowly decompose, introduced with, for example, a reactant gas over a period of time, or a combination thereof to provide a continuous and/or long-term cleaning and activation of the fuel cell, even during periods of fuel cell operation. The selection of a particular cleaning agent can depend upon the nature of the materials and of active surfaces to be cleaned. For example, a thin, fragile, electrolyte sheet can be easily damaged if subjected to physical handling associated with an aqueous cleaning solution. A gaseous cleaning agent can be more suited to such electrolyte materials, while an aqueous solution can be better suited to a thick tubular electrolyte material. Cleaning agents, such as acidic and/or basic solutions, solvents, gases, and solids are commercially available (Sigma-Aldrich, St. Louis, Mo., USA) and one of skill in the art could readily select an appropriate cleaning agent for a particular fuel cell or component.

The contacting step of the present invention can comprise various embodiments. The contacting step can comprise any method of contacting the cleaning agent with at least a portion of an active surface. In one embodiment, the contacting comprises immersing at least a portion of the electrolyte and/or electrode comprising an active surface into a solution or solvent comprising the cleaning agent. In another embodiment, the contacting comprises spraying and/or coating at least a portion of an active surface with a cleaning agent. In another embodiment, the contacting step comprises exposing at least a portion of an active surface to a gas and/or vapor comprising a cleaning agent.

The time and temperature at which the cleaning agent is contacted with at least a portion of an active surface can be dependent upon the specific impurity to be removed and the concentration of the cleaning agent. In general, a more concentrated cleaning agent can be contacted at a lower temperature and/or a shorter period of time than a less concentrated cleaning agent. In a specific embodiment, a portion of an active surface is contacted with an aqueous solution comprising about 3 wt. % hydrogen fluoride, wherein the contacting is performed at ambient temperature (e.g. from about 25° C. to about 35° C.) for about 20 minutes. In another embodiment, a portion of an active surface is contacted with an aqueous solution of from about 0.5 wt. % to about 2.5 wt. % hydrogen fluoride, and wherein the contacting is performed at a temperature of from about 35° C. to about 60° C. for about 20 minutes. In yet another embodiment, a portion of an active surface is contacted with an aqueous solution of from about 5 wt. % to about 15 wt. % hydrogen chloride, and wherein the contacting is performed at a temperature of from about 40° C. to about 80° C. for about 20 minutes.

The method of the present invention can further comprise an optional step of contacting at least a portion of the active surface with a neutralizing agent, and/or rinsing the at least a portion of the active surface with water. The optional neutralizing agent can comprise any such agent suitable for use in a solid oxide fuel cell that can neutralize a cleaning agent such as, for example, an acidic and/or basic solution. The neutralizing agent can neutralize at least a portion of an acidic and/or basic solution in contact with or remaining on at least a portion of an active surface, after contacting with the cleaning agent. It is not necessary that the cleaning agent be completely neutralized. In one embodiment, a basic or alkaline neutralizing agent is contacted with at least a portion of an active surface to neutralize at least a portion of an acidic cleaning solution in contact with the active surface. In another embodiment, an acidic neutralizing agent is contacted with at least a portion of an active surface to neutralize at least a portion of a basic cleaning solution in contact with the active surface. The concentration and composition of a neutralizing agent can vary depending upon the concentration and composition of the cleaning agent used and the amount of cleaning agent remaining in contact with at least a portion of the active surface. In one embodiment, the neutralizing agent is a dilute (3%) aqueous ammonia solution designed to neutralize at least a portion of an acidic cleaning agent solution such as, for example, a solution of hydrofluoric acid. Neutralizing agents are commercially available (Sigma-Aldrich, St. Louis, Mo., USA) and one of skill in the art could readily select an appropriate neutralizing agent for a particular fuel cell, component, and/or cleaning agent.

The portion of the active surface contacted with a cleaning agent can also be rinsed, either in lieu of, or in addition to, contacting with a neutralizing agent. In one embodiment, at least a portion of an active surface is contacted with a neutralizing agent after contacting with a cleaning agent. In a further embodiment, the portion of the active surface contacted with a cleaning agent and a neutralizing agent can be rinsed with water. In another embodiment, a portion of an active surface contacted with a cleaning agent is rinsed with water and no neutralizing step is performed. In yet another embodiment, neither a neutralizing step nor a rinsing step is performed. The water, if an optional rinsing step is used, can comprise any purified water such as, for example, distilled, deionized, or distilled deionized water.

The method of the present invention can further comprise an optional step of heating the cleaned surface after contacting with the cleaning agent. Such a heating step can result in further cleaning or removal of segregated impurities.

### Fuel Cell Fabrication and Regeneration

The cleaning method of the present invention can be performed at various times prior to, during, or subsequent to fuel cell fabrication. In one embodiment, a ceramic electrolyte can be subjected to the cleaning method of the present invention prior to having electrodes attached and/or being assembled in a solid oxide fuel cell. In another embodiment, an electrolyte comprising an anode and/or a cathode can be subjected to the cleaning method of the present invention prior to fuel cell assembly. In yet another embodiment, the assembled components of a solid oxide fuel cell can be subjected to the cleaning method of the present invention. In a specific embodiment, an assembled fuel cell can be cleaned or ‘flash activated’ by passing a gaseous cleaning agent through the reactant gas channels. The fuel cell can then be optionally flushed with an inert gas prior to operation.

In another embodiment, the cleaning method of the present invention can be used to regenerate a solid oxide fuel cell after a period of operation. In a specific embodiment, a fuel cell is assembled and operated for a period of time, wherein during operation, at least a portion of an impurity positioned within either the fuel cell components and/or the reactant gas streams segregates at a portion of an active surface within the fuel cell. Glass frit seals in a solid oxide fuel cell can contribute significantly to the segregation of glass forming impurities on an active surface. After a period of operation, the flow of reactant gases can be suspended, and at least a portion of the active surface of the fuel cell contacted with a cleaning agent to remove at least a portion of a segregated impurity. The contacting can comprise disassembly of the fuel cell or use of reactant gas channels to contact a cleaning agent with at least a portion of an active surface of an intact and assembled fuel cell. In one embodiment, the flow of reactant gases is suspended and the reactant gas flow channels utilized to flow a stream of a cleaning agent gas, such as, for example, hydrogen fluoride, through the assembled cell, thus contacting the gaseous cleaning agent with at least a portion of an active surface of the fuel cell. After contacting for a sufficient time to remove at least a portion of the segregated impurity, the fuel cell can optionally be flushed with an inert gas, a neutralizing agent, water, or a combination thereof, and the original flow of reactant gas restored. Such transient regeneration of a fuel cell can remove at least a portion of the segregated impurities that accumulate during fuel cell operation and can extend the life and performance of a solid oxide fuel cell.

### Properties of a Cleaned Component

The methods of the present invention provide a process whereby a ceramic electrolyte, an electrode, and/or a solid oxide fuel cell can be rendered free of or substantially free of surface segregated impurities such as, for example glass forming impurities and/or passivating species. In one embodiment, a surface of a ceramic electrolyte, an electrode, and/or a solid oxide fuel cell cleaned by the methods of the present invention comprise less than about 10% cation %, for example, less than about 10, 9, 7, 5, 3, 2, or 1 cation %, or preferably less than about 2 cation %, for example, less than about 2, 1.5, 1, 0.5, 0.3, 0.2, 0.1, or 0.05 cation % of segregated impurities. Expressed in atomic %, segregated impurities, if present, are in one embodiment less than about 5 atomic %, for example less than about 5, 4, 3, 2, or 1 atomic %, or preferably less than about 1 atomic %, for example, less than about 1, 0.8, 0.4, 0.2, or 0.1 atomic %.

In another embodiment, a surface of a ceramic electrolyte, an electrode, and/or a solid oxide fuel cell comprises less than about 2 cation %, for example less than 2, 1.5, 1, 0.5, 0.4, 0.3, 0.2, or 0.1 cation % of a combination of oxides of silicon, phosphorus, boron, and optionally oxides of aluminum, sodium, and potassium, if an oxide of either silicon, phosphorus, or boron is present. In yet another embodiment, a surface of a ceramic electrolyte, an electrode, and/or a solid oxide fuel cell comprises less than about 0.4 cation %, for example less than 0.4, 0.3, 0.2, 0.1, 0.05, or 0.01 cation % of a combination of silicon, phosphorus, and boron.

In another embodiment, the methods of the present invention can remove all or substantially all segregated impurities from at least a portion of an active surface of a fuel cell component, such as an electrolyte and/or electrode. In a specific embodiment, the surface of a ceramic electrolyte cleaned in accordance with the present invention is substantially free of oxides of silicon, phosphorus, and boron.

Although several embodiments of the present invention have been illustrated in the accompanying drawings and described in the detailed description, it should be understood that the invention is not limited to the embodiments disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the electrolytes, electrodes, fuel cells, articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### HF Cleaning of Electrolyte

In a first example, yttria stabilized zirconia electrolytes were analyzed both prior to and subsequent to a cleaning procedure. Electrolytes were prepared from high purity grade 3YSZ powder containing about 30 ppm silica and about 50 ppm alumina (available from Tosoh Corporation, Grove City, Ohio, USA) using a slip casting process with an organic medium containing 300-500 ppm alumina, 30-100 ppm silica, 20-30 ppm titania, 20-30 ppm iron, 20-30 ppm calcium, 2-5 ppm sodium, and 100-400 ppm phosphorus. The prepared electrolytes were fired at various temperatures. XPS analysis of the as prepared (fired) electrolytes indicated a surface enrichment of the impurities. Specific values for XPS measurements are illustrated in Tables 1 (a) and 1 (b) below.

TABLE 1(a)
XPS analysis of electrolyte prior to cleaning (atomic %)

| Electrolyte # | C1s | O1s | Na1s | Mg1s | Al2p | Si2p | P2p | Y3d | Zr3d | Mo3d |
|---|---|---|---|---|---|---|---|---|---|---|
| 1 | 11.4 | 57.6 | 2.3 | | 1.6 | 2.3 | 0.5 | 3.9 | 20.4 | — |
| 2 | 11.0 | 58.6 | 2.2 | | 1.5 | 2.8 | 0.3 | 3.7 | 19.9 | — |
| 3 | 12.3 | 56.7 | 2.8 | | 2.1 | 3.2 | — | 3.5 | 19.5 | — |
| 4 | 13.0 | 56.4 | 2.8 | | 1.4 | 2.3 | 0.2 | 3.7 | 20.2 | — |
| 5 | 12.6 | 57.1 | 2.1 | | 1.8 | 2.2 | 0.5 | 3.9 | 19.8 | — |
| 6 | 10.34 | 58.23 | 1.47 | 0.31 | 1.22 | 1.45 | 1.52 | 4.4 | 20.79 | 0.01 |
| 7 | 13.77 | 55.27 | 1.46 | 0.1 | 0.53 | 0.2 | 2.11 | 5.23 | 20.78 | 0.22 |
| 8 | 14.78 | 64.43 | 1.00 | 0.05 | 0.47 | 0.11 | 1.02 | 4.62 | 22.11 | 0.45 |
| 9 | | 65.3 | 0.3 | — | 1.14 | 0.26 | 3.02 | 6.08 | 23.8 | — |
| 10 | | 66.3 | 0.5 | — | 0.7 | 0.6 | 1.0 | 6.0 | 24.5 | — |

The high carbon concentrations are due to storage of fired sheets in plastic containers and exposure of the electrolyte sheets to air. The data described in Table 1 illustrates peak intensities.

TABLE 1(b)
XPS analysis of electrolyte prior to cleaning (cation %)

| | cat % | cat % | cat % | cat % | | | cat % |
|---|---|---|---|---|---|---|---|
| Electrolyte # | Na | Mg | Al | Si | cat % P | cat % Y | Zr |
| 1 | 6.59 | | 4.58 | 6.59 | 1.43 | 11.17 | 58.45 |
| 2 | 6.34 | | 4.32 | 8.07 | 0.86 | 10.66 | 57.35 |
| 3 | 7.69 | | 5.77 | 8.79 | 0.00 | 9.62 | 53.57 |
| 4 | 8.16 | | 4.08 | 6.71 | 0.58 | 10.79 | 58.89 |
| 5 | 6.12 | | 5.25 | 6.41 | 1.46 | 11.37 | 57.73 |
| 6 | 4.34 | 0.92 | 3.61 | 4.28 | 4.49 | 13.00 | 61.44 |
| 7 | 4.66 | 0.32 | 1.69 | 0.64 | 6.73 | 16.68 | 66.26 |
| 8 | 3.29 | 0.16 | 1.55 | 0.36 | 3.35 | 15.19 | 72.71 |
| 9 | 0.83 | | 3.17 | 0.72 | 8.39 | 16.89 | 66.11 |
| 10 | 1.45 | | 2.02 | 1.73 | 2.89 | 17.34 | 70.81 |

The prepared electrolytes were then subjected to a cleaning procedure in accordance with one embodiment of the present invention. The fired and unprinted electrolytes were placed in a solution of 3% hydrofluoric acid for about 30 minutes. The electrolytes were removed and rinsed with a 3% aqueous ammonia solution, followed by a rinse with deionized water.

After cleaning, the electrolytes were again subjected to XPS analysis. The surface concentrations measured after HF cleaning for two of the electrolytes listed in Table 1, above, are detailed in Tables 2(a) and 2(b) below. The HF cleaning procedure resulted in a significant decrease in the surface concentration of segregated impurities.

TABLE 2(a)
XPS analysis of electrolyte after cleaning (atomic %)

| # | C1s | O1s | F1s | Na1s | Al2p | Si2p | P2p | Y3d | Zr3d |
|---|---|---|---|---|---|---|---|---|---|
| 9B | | 67.5 | 1.99 | 0.1 | 1.6 | <0.1 | 0.2 | 2.6 | 25.9 |
| 10B | 17.6 | 43.5 | 14.2 | 1.4 | 0.5 | 0.1 | 0.2 | 5.2 | 17.8 |

TABLE 2(b)
XPS analysis of electrolyte after cleaning (cation %)

| # | cat % Na | cat % Al | cat % Si | cat % P | cat % Y | cat % Zr |
|---|---|---|---|---|---|---|
| 9B | 0.33 | 5.25 | 0.30 | 0.66 | 8.53 | 84.95 |
| 10B | 5.56 | 1.98 | 0.40 | 0.79 | 20.63 | 70.63 |

The XPS data in Tables 1 and 2, above, illustrates the reduction of segregated impurities, such as silicon and phosphorus, that can be achieved with the cleaning and activation methods of the present invention.

### Example 2

### HF Cleaning of Cathode

In a second example, an active cathode surface was subjected to the HF cleaning procedure described in Example 1. A lanthanum strontium manganate (La_{0.8}Sr_{0.2}Mn_{(1+delta)}O₃/3YSZ) cathode was printed on one side of an electrolyte fabricated from 3YSZ powder (Tosho Corporation). XPS analysis of the prepared cathode indicated a surface silicon concentration of 5 atomic % (equivalent to 18 cation %). After application of the above described cleaning procedure, the silicon surface concentration dropped to about 1.2 atomic % (equivalent to 4 cation %) on the rinsed cathode. Due to the porous nature of the electrode structure, a significant amount of HF can be trapped within the matrix of the electrode and/or electrolyte. Upon heating, this trapped HF reacted further with residual surface segregated silicon, phosphorus, and boron to yield a further cleaned electrode.

### Example 3

### SIMS Analysis of Cathode

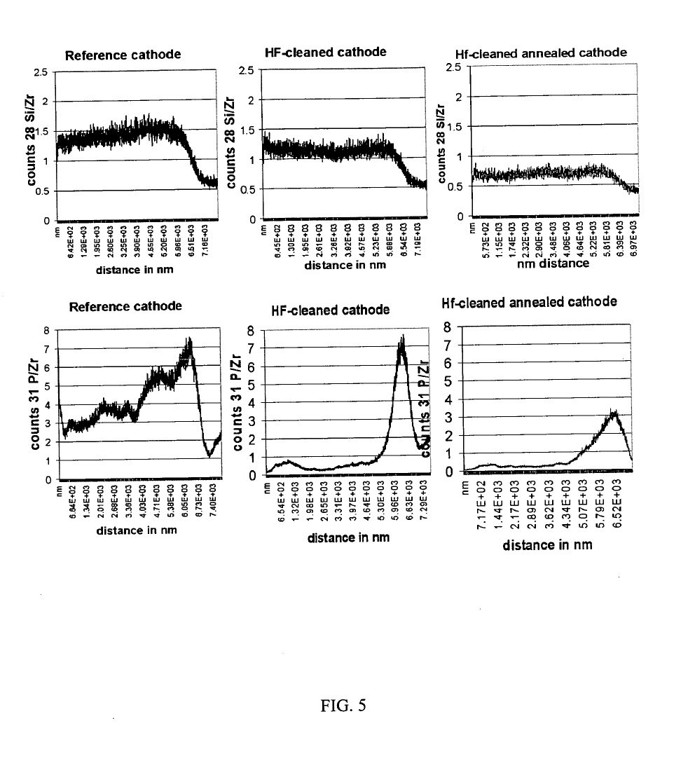

In a third example, a series of LSM/3YSZ porous cathodes were prepared and analyzed by secondary ion mass spectrometry (SIMS) prior to cleaning, after cleaning with a 3% HF solution, and after heating the HF cleaned electrode to 700° C., to provide a depth profile of the detected impurities. FIG. 5 illustrates representative depth profiles obtained for silicon and phosphorus on cathode samples. The intensity of each signal was normalized to the intensity of the zirconium signal. Large step-like changes in concentration are representative of the interface between the cathode and the electrolyte of the samples. For both silicon and phosphorus, significant reductions in concentration were achieved after HF cleaning. As described herein, heating a surface after cleaning can enhance the cleaning effect. This effect is demonstrated in the depth profiles of HF-cleaned annealed cathodes, wherein substantially all of the silicon and phosphorus were removed from the cathode surface.

### Example 4

### HF Cleaning of Anode

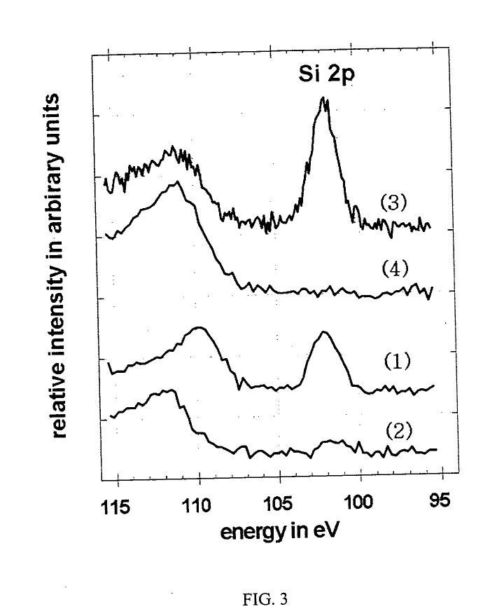

In a fourth example, a Ni-based anode was prepared by screen printing NiO/8YSZ on the surface of a 3YSZ electrolyte and firing the printed electrolyte. As illustrated in FIG. 3, XPS analysis indicated a high surface concentration of silicon in the as-prepared anode (1). The prepared electrode was then subjected to the HF cleaning procedure of Example 1. XPS analysis on the cleaned anode (2) indicated a significant drop in the concentration of silicon on the anode surface. To demonstrate the efficiency of the HF cleaning procedure of the present invention, a separate anode was prepared as described above and polluted by exposing the anode to a borosilicate material for an extended period of time (3). XPS analysis of the polluted anode indicated a large surface concentration of silicon. When the polluted anode was subjected to the same HF cleaning procedure (4), the surface concentration of silicon dropped and was comparable to that of the cleaned, un-polluted anode (2). Quantification of XPS data indicates that surface concentrations of less than 1 atomic % silicon are achievable through the use of the cleaning method of the present invention.

### Example 5

### Performance of Cleaned Electrode

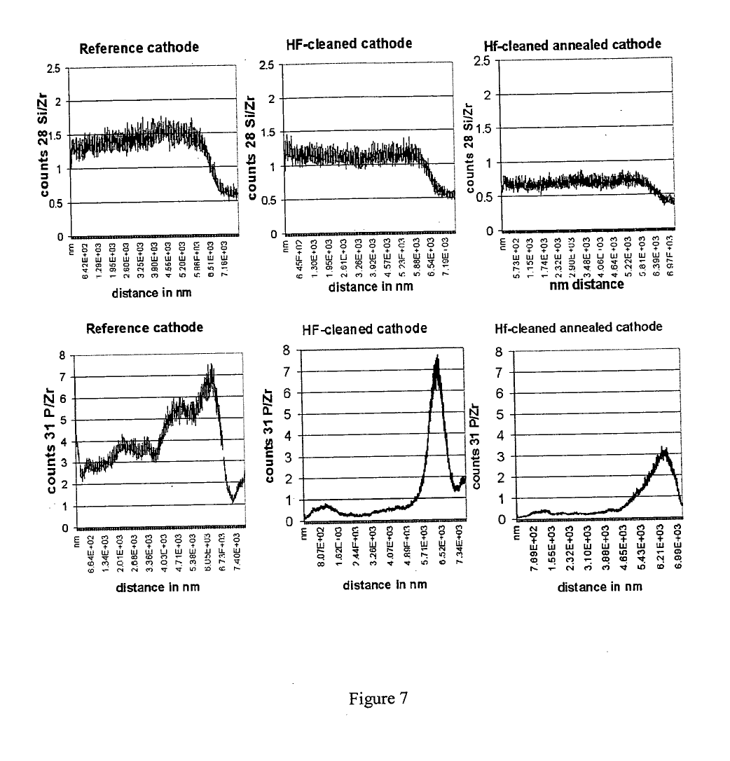

In a fifth example, the electrochemical performance of a cathode was examined using impedance spectroscopy. Impedance spectroscopy was used to identify the charge transfer process as the slowest step in the oxygen incorporation reaction sequence of the example device. Surface segregation of silica makes oxygen incorporation at the triple phase boundary between the gas phase, the LSM and the YSZ difficult. Impedance spectra of the 3YSZ electrolyte of Example 1, sandwiched between two electrodes comprising an LSM/YSZ layer topped with a Ag based current collector (a cathode/cathode device), were compared for the following: standard as-prepared cell, a cell prepared with an HF cleaned electrolyte, and a cell prepared with an HF cleaned electrolyte that was further cleaned with HF after preparation of the cathode. Impedance spectroscopy can separate the resistance of various electrode processes, including the charge transfer process and the oxygen adsorption/dissociation processes. Analysis of the resulting impedance spectroscopy data at 750° C. in air indicated that the cathode resistance due to oxygen adsorption remained unchanged after HF cleaning. The resistance due to the charge transfer process decreased slightly for the cell prepared with an HF cleaned electrolyte, and decreased significantly for the cell cleaned with HF after preparation of the cathode, as illustrated in FIG. 7. The charge transfer resistance for a 1 cm² area was 0.2 ohm for the as-processed cathode, 0.175 ohm for the cell with surface-cleaned electrolyte, and 0.07 ohm for the fully cleaned cathode

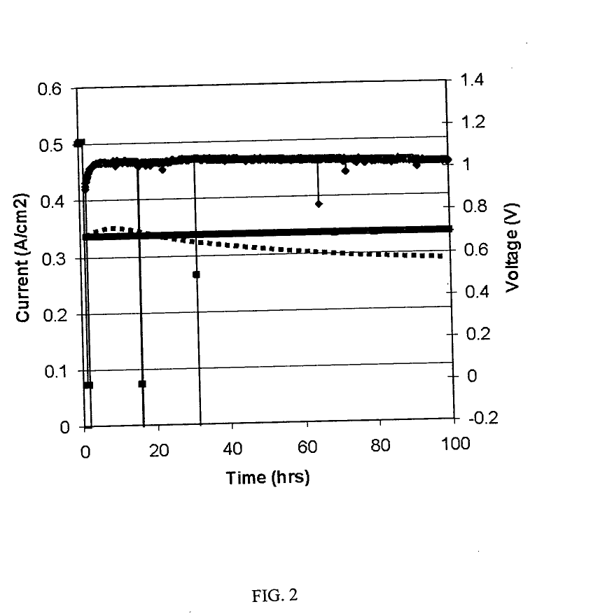

The decrease in cathode charge transfer resistance was associated with an increase in the current density of the cathode, as measured with a cathode/cathode cell. FIG. 2 illustrates the current densities of a standard as-prepared cathode/cathode single cell (dotted line) and a fully HF cleaned cathode/cathode single cell (solid line) at 750° C. in air. The fully HF cleaned cell exhibited an improvement in current density of greater than 100% relative to the as-prepared cell. Thus, a significant improvement in the power density and efficiency of a solid oxide fuel cell can be attained by using an HF cleaning process.

### Example 6

### Long Term Performance of Cleaned Electrodes

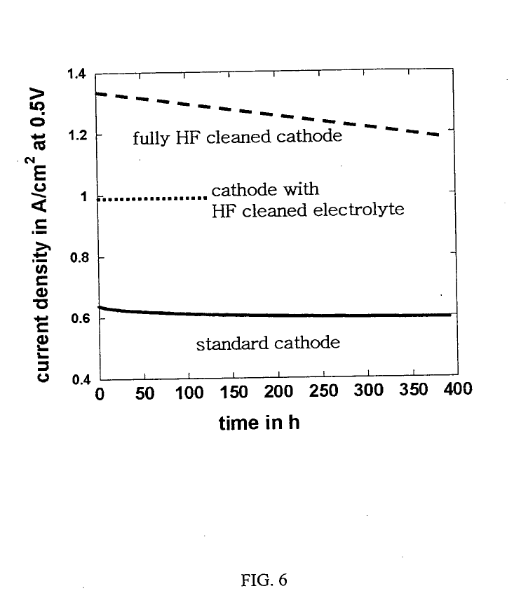

In a sixth example, a series of test cells were evaluated to determine long term performance after HF cleaning. The first test cell comprised a fully HF cleaned LSM/3YSZ cathode/cathode cell and, as illustrated in FIG. 6, exhibited an initial performance of 1.27 A/cm² at an applied pump voltage of 0.5V and 750° C., compared to about 1 A/cm² for a cathode with an HF cleaned electrolyte and about 0.6 A/cm² for an as-prepared (un-cleaned) cathode. An initial decrease in the current density of the fully HF cleaned cathode was due to pollution from the test cell equipment. Such pollution could be removed with a regenerative cleaning step, in accordance with various embodiments of the present invention. The test cell maintained this performance at 750° C. for more than 70 days, as measured by current-voltage (i-V) curves. After 70 days, the current density remained greater than 1.2 A/cm², demonstrating that a permanent improvement of cathode performance can be achieved by HF cleaning, and that performance does not significantly degrade in a clean environment at fuel cell operating temperatures in the range of 600° C. to 750°.

The second test cell comprised a single cell device comprising a 3YSZ electrolyte sheet sandwiched between an LSM/3YSZ cathode and a Ni/8YSZ anode, and the Ag-based current collectors. Two versions of this cell were constructed: one as-prepared (un-cleaned), and one in which the anode, cathode, and electrolyte were HF cleaned according to the procedure described in Example 1. The cells were mounted in ceramic test holders, operated at 725° C. in air (cathode) and 30% hydrogen (anode), and their performance evaluated while in an alumina tube furnace. The cleaned version of the cell exhibited an initial power density greater than that of the as-prepared version. Within the first hour, the performance of the cleaned cell increased, reaching a stable value of 0.47-0.49 A/cm² at 0.7 volts. No measurable performance degradation was observed in over 180 hours of operation. The as-prepared version of the cell exhibited a lower initial power density and suffered continuous performance degradation. The initial current density of the as-prepared version of the cell was 0.35 A/cm² at 0.7 volts, and less than 0.3 A/cm² after 180 hours of operation. Thus, the power density of the cleaned version of the cell was improved by about 40% over that of the as-prepared version.

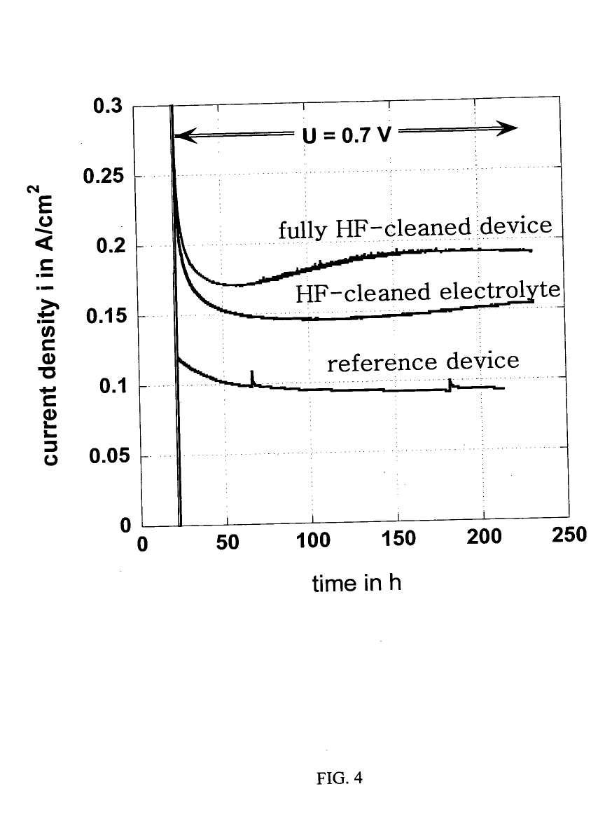

The third test cell comprised a single cell with a Ni/8YSZ anode and a platinum/YSZ counter electrode. Three versions of this cell were constructed: one in which the anode and electrolyte were fully cleaned with HF; one in which the electrolyte alone was cleaned with HF; and one as-prepared with no HF cleaning. All three cells were operated at 725° C. in air and 30% hydrogen. Current density was then measured on each of the versions as a function of time at 0.7 volts, as illustrated in FIG. 4. The first version of the cell (fully cleaned) exhibited an initial performance loss of about 14%, but recovered to approximately the initial performance after 48 hours of operation. The second version (cleaned electrolyte) exhibited a performance loss of about 36% in the initial 48 hours of operation, after which performance appeared to stabilize. The third version (as-prepared) exhibited an initial performance loss of greater than 35% in the initial 48 hours of operation, and continued to suffer further losses during continued operation.

The benefits of cleaning the electrolyte and/or the electrodes of a solid oxide fuel cell manifest in improved initial power density, as well as improved long-term performance of the cell. Cells in which electrodes were fully cleaned, in addition to the electrolyte, exhibited substantially improved long-term performance.

### Example 7

### Hydrogen Cleaning of Anode

In a seventh example, various anode compositions detailed in Table 3, below, were heated in a furnace to about 700° C. and exposed to a gas stream comprising about 3% hydrogen and 97% nitrogen for 100 hours. The samples were subsequently quenched to room temperature in the hydrogen/nitrogen gas stream prior to XPS analysis. The results of the XPS analysis are detailed in Table 3.

TABLE 3
XPS of Anode Hydrogen Cleaning Experiments

| Sample | C1s | O1s | Na1s | Si2p | Mn2p | Fe2p | Ni2p | Y3d | Zr3d |
|---|---|---|---|---|---|---|---|---|---|
| NiO(Fe)/8YSZ | 2.09 | 63.31 | 2.98 | 2.08 | — | 0.68 | 9.18 | 4.28 | 16.91 |
| (uncleaned) | | | | | | | | | |
| NiO(Fe)/8YSZ | 2.34 | 61.91 | 1.49 | 1.63 | — | — | 6.91 | 4.31 | 20.82 |
| (cleaned with H₂) | | | | | | | | | |
| NiO(Cu)/8YSZ | 3.05 | 61.43 | 3.58 | 2.16 | — | — | 8.51 | 4.24 | 17.04 |
| (uncleaned) | | | | | | | | | |
| NiO(Cu)/8YSZ | 3.26 | 59.14 | 1.65 | 1.48 | — | — | 7.66 | 4.99 | 20.20 |
| (cleaned with H₂) | | | | | | | | | |
| NiO(Mn)/8YSZ | 18.45 | 51.10 | 3.86 | 1.16 | 1.63 | — | 5.25 | 3.44 | 14.28 |
| (uncleaned) | | | | | | | | | |
| NiO(Mn)/8YSZ | 12.82 | 57.03 | 0.21 | 1.09 | 0.11 | — | 4.88 | 4.25 | 18.56 |
| (cleaned with H₂) | | | | | | | | | |

As detailed in Table 3, above, the hydrogen cleaning method of the present invention can effectively lower the surface concentration of segregated impurities, such as silicon, nickel, and sodium.

Various modifications and variations can be made to the compositions, articles, devices, and methods described herein. Other embodiments of the compositions, articles, devices, and methods described herein will be apparent from consideration of the specification and practice of the compositions, articles, devices, and methods disclosed herein. It is intended that the specification and examples be considered as exemplary.

What is claimed is:

1. A ceramic electrolyte comprising at least one surface, wherein at least a portion of at least one surface is substantially free of segregated impurities.

2. The ceramic electrolyte of claim 1, wherein the at least a portion of the at least one surface is substantially free of oxides of silicon, phosphorus, and boron.

3. The ceramic electrolyte of claim 1, wherein the at least a portion of the at least one surface is substantially free of a combination of:
an oxide of at least one of silicon, phosphorus, or boron, or a combination thereof; and
an oxide of at least one of aluminum, sodium, or potassium, or a combination thereof.

4. The ceramic electrolyte of claim 1, wherein the at least a portion of the at least one surface comprises from 0 to less than about 2 cation % of silicon, phosphorus, and boron.

5. The ceramic electrolyte of claim 1, wherein the at least a portion of the at least one surface comprises from 0 to less than about 0.4 cation % of silicon, phosphorus, and/or boron.

6. The ceramic electrolyte of claim 1, wherein the at least one surface comprises an external surface.

7. The ceramic electrolyte of claim 1, wherein the at least one surface comprises an internal surface.

8. The ceramic electrolyte of claim 1, wherein the ceramic electrolyte comprises a polycrystalline ceramic comprised of:
zirconia, yttria, scandia, or ceria, or a combination thereof, and optionally being doped with at least one dopant selected from the group consisting of the oxides of Y, Hf, Ce, Ca, Mg, Sc, Nd, Sm, Eu, Gd, Tb, Dy, Ho, Er, Tm, Yb, Lu, In, Ti, Sn, Nb, Ta, Mo, or W, or a mixture thereof.

9. A solid oxide fuel cell electrode having at least one active surface, wherein at least a portion of the at least one active surface is substantially free of segregated impurities.

10. The solid oxide fuel cell electrode of claim 9, wherein the at least a portion of the at least one active surface is substantially free of oxides of silicon, phosphorus, and boron.

11. The solid oxide fuel cell electrode of claim 9, wherein the at least one active surface is substantially free of oxides of silicon, phosphorus, and boron.

12. The solid oxide fuel cell electrode of claim 9, wherein the solid oxide fuel cell electrode is a cathode comprising at least one of yttria, zirconia, manganate, cobaltate, or ferrate, or a combination thereof.

13. The solid oxide fuel cell electrode of claim 9, wherein the solid oxide fuel cell electrode is an anode comprising at least one of yttria, zirconia, nickel, or a combination thereof.

14. A solid oxide fuel cell comprising:
an anode and a cathode, each comprising an active surface; and
an electrolyte having a surface;
wherein at least a portion of each of the cathode active surface, the anode active surface, and the electrolyte surface are substantially free of segregated impurities.

15. A ceramic article comprising at least one surface, wherein at least a portion of at least one surface is substantially free of segregated impurities.

16. A method for removing at least a portion of a segregated impurity from at least a portion of an active surface of a component of an assembled or unassembled solid oxide fuel cell comprising contacting at least a portion of the active surface with a cleaning agent, wherein the contacting is at a time and temperature sufficient to remove substantially all of the at least a portion of the segregated impurity.

17. The method of claim 16, wherein the cleaning agent comprises at least one of:
an acidic and/or basic solution capable of dissolving the at least a portion the segregated impurity,
an organic solvent capable of dissolving the at least a portion of the segregated impurity,
a gas capable of removing the at least a portion of the segregated impurity, or a combination thereof.

18. The method of claim 16, further comprising first contacting the at least a portion the segregated impurity with a reactant gas capable of changing the oxidation state of at least a portion of the segregated impurity.

19. The method of claim 16, wherein the segregated impurity comprises a glass forming material.

20. The method of claim 19, wherein the segregated impurity comprises:
at least one of an oxide of silicon, phosphorus, boron, or a combination thereof, and
optionally at least one of an oxide of aluminum, sodium, potassium, or a combination thereof.

21. The method of claim 16, wherein the at least a portion of the active surface is a part of at least one electrode.

22. The method of claim 16, wherein the at least a portion of the active surface is a part of a ceramic electrolyte comprising a polycrystalline ceramic comprised of:
zirconia, yttria, scandia, or ceria, or a combination thereof, and optionally being doped with at least one dopant selected from the group consisting of the oxides of Y, Hf, Ce, Ca, Mg, Sc, Nd, Sm, Eu, Gd, Tb, Dy, Ho, Er, Tm, Yb, Lu, In, Ti, Sn, Nb, Ta, Mo, or W, or a mixture thereof.

23. The method of claim 16, wherein the cleaning agent comprises an acidic solution comprising at least one of hydrofluoric acid, or hydrochloric acid, or a combination thereof.

24. The method of claim 16, wherein the cleaning agent comprises a gas comprising at least one of a fluorinated gas, a chlorinated gas, or a combination thereof.

25. The method of claim 16, wherein the cleaning agent comprises hydrogen gas and wherein the contacting occurs during a period in which the solid oxide fuel cell is not operating.

26. The method of claim 16, wherein the cleaning agent comprises a gas comprising at least one of fluorine, hydrogen fluoride, nitrogen trifluoride, or a combination thereof.

27. The method of claim 16, wherein the cleaning agent comprises an acidic solution comprising an aqueous solution comprising about 3 wt. % hydrogen fluoride, and wherein contacting is at ambient temperature.

28. The method of claim 16, wherein the cleaning agent comprises an acidic solution comprising an aqueous solution comprising from about 0.5 wt. % to about 2.5 wt. % hydrogen fluoride, and wherein the contacting is at a temperature of from about 35° C. to about 60° C.

29. The method of claim 16, wherein the cleaning agent comprises an acidic solution comprising an aqueous solution comprising from about 5 wt. % to about 15 wt. % hydrogen chloride, and wherein the contacting is at a temperature of from about 40° C. to about 80° C.

30. The method of claim 16, further comprising:
optionally contacting the at least a portion of the active surface with a neutralizing agent, after contacting with a cleaning agent; and/or rinsing the at least a portion of the active surface with water.

31. The method of claim 30, wherein the neutralizing agent comprises an aqueous ammonia solution.

32. The method of claim 16, wherein the at least a portion of the active surface is positioned in an assembled solid oxide fuel cell.

33. The method of claim 16, wherein the contacting occurs on a repeated basis after a period of fuel cell operation to periodically regenerate the at least a portion of the at least one active surface.

34. An active surface cleaned by the method of claim 16.
